(19) United States
(12) Patent Application Publication
(10) Pub. No.: US 2017/0009646 A1
(43) Pub. Date: Jan. 12, 2017

(54) PORTABLE WORK MACHINE

(71) Applicant: MAKITA CORPORATION, Anjo-shi, Aichi (JP)

(72) Inventors: Kenji IMAFUKU, Tachikawa-shi (JP); Yoshio SEKI, Tachikawa-shi (JP)

(73) Assignee: MAKITA CORPORATION, Anjo-shi, Aichi (JP)

(21) Appl. No.: 15/113,149

(22) PCT Filed: Jan. 30, 2015
(86) PCT No.: PCT/JP2015/052654

§ 371 Date: Jul. 21, 2016

(30) Foreign Application Priority Data
Jan. 31, 2014 (JP) 2014-017468

(51) Int. Cl. F02B 63/02; F02F 7/00; F02P 13/00

(52) U.S. Cl. CPC F02B 63/02; F02P 13/00; F02F 7/0065

(57) ABSTRACT

The present invention relates to a portable work machine including an engine placed in an internal space of an engine case, an ignition coil for igniting the engine provided closer to the engine, and a high voltage cord routed to connect the ignition coil to an ignition plug of the engine. The portable work machine includes a passage portion for housing and guiding the high voltage cord on a route from an area in which the ignition coil is placed to an area in which the ignition plug is placed, in which the passage portion is arranged on an upper face side of the engine case.

### TECHNICAL FIELD

The present invention relates to a portable work machine, such as a chainsaw, a brush cutter or an air blower, which is driven by an engine, specifically to a portable work machine in which a routing structure for a high voltage cord that connects an ignition coil for igniting the engine to an ignition plug is improved so as to increase durability and ease of assembly and maintenance of the high voltage cord with respect to the engine case while curbing a decrease in a secondary voltage for ignition.

### BACKGROUND ART

In a conventional portable work machine of this type, such as a chainsaw, an engine is placed in the internal space of an engine case which has a C shape when viewed from a side, and an ignition coil for igniting the engine is disposed utilizing the engine case. In addition, a high voltage cord is routed to connect the ignition coil to the ignition plug of the engine, and an operation handle is placed on the upper wall of the engine case (see Patent Document 1, for example).

Another example of such a conventional portable work machine is a portable chainsaw (see FIGS. 1 and 3 of Patent Document 2, for example) configured as follows. In the portable chainsaw, the blades of an air-cooling fan are attached to the flywheel, and an air conduit is formed to surround a part of the outer periphery of the flywheel so that the discharge opening of the air conduit can be directed to the cylinder part of the engine. The magneto coil is placed so as to face the outer periphery of the flywheel, and the cord from the magneto coil is enclosed by the outer edge of the coil support for supporting the magneto coil.

### REFERENCE DOCUMENT LIST

### Patent Documents

Patent Document 1: U.S. Pat. No. 7,168,132

Patent Document 2: JP A 2010-133305

### SUMMARY OF THE INVENTION

### Problems to be Solved by the Invention

The chainsaw disclosed in Patent Document 1 is made lightweight and small by, for example, horizontally positioning the engine in the internal space of the engine case having a C shape when viewed from a side, and by mounting a carburetor in the engine case and an operation handle thereon. In such a chainsaw, the ignition coil for igniting the engine is usually located at a first side end on one side (left side, for example) of the engine case while the ignition plug for the engine is located at a second side end, which is located opposite to the first side end, on the other side (right side, for example) of the engine case. In this case, the high voltage cord is routed to the ignition plug within the engine case usually in close contact with the engine all along the route between the opposite sides of the engine case. As a result, the high voltage cord is routed over a considerably long path from the ignition coil to the ignition plug.

Such a routing structure requires a large number of man-hours for routing the high voltage cord during assembly and maintenance work of the machine including disassembly and replacement of the cord. During maintenance work in particular, removing side covers on opposite sides and taking the engine block out would be needed before repairing or replacing the high voltage cord. In addition, routing the high voltage cord over a considerably long path along the vicinity of the metal parts would reduce the durability of the high voltage cord as well as the secondary voltage for ignition, since the metal parts vibrate and reach high temperatures while the engine is running.

In the portable chainsaw disclosed in Patent Document 2, in which the engine is, for example, vertically placed, the magneto coil is placed on one side of the cylinder part of the engine so as to face the outer periphery of the flywheel, and the ignition plug is provided on the top of the cylinder part. Thus, the cord of the magneto coil has been routed over a considerably long path from the magneto coil to the ignition plug. This requires a large number of man-hours for routing the cord of the magneto coil during assembly and maintenance work of the machine including disassembly and replacement of the cord, as well. In addition, routing the cord of the magneto coil over a considerably long path along the vicinity of the metal parts would reduce the durability of the high voltage cord as well as the secondary voltage for ignition, since the metal parts vibrate and reach high temperatures while the engine is running.

In the chainsaw disclosed in Patent Document 1, an approximately rectangular piping hole for a pipe which lets an air-fuel mixture pass through to the engine is formed in an area which is located between the engine and the operation handle in the upper wall of the engine case and through which the air-fuel mixture passage passes. However, the approximately rectangular piping hole formed in the upper wall of the engine case would reduce strength and stiffness of the upper wall of the engine case.

To address these problems, the present invention has been made to provide a portable work machine in which the routing structure for the high voltage cord that connects the ignition coil for igniting the engine to the ignition plug is improved so as to increase durability and ease of assembly and maintenance of the high voltage cord with respect to the engine case to curb a decrease in the secondary voltage for ignition.

### Means for Solving the Problems

To solve the problems described above, in a portable work machine according to the present invention includes an engine placed in an internal space of an engine case, an ignition coil for igniting the engine disposed utilizing the engine case, and a high voltage cord routed to connect the ignition coil to an ignition plug of the engine. The portable work machine further includes a passage portion for housing and guiding the high voltage cord on a route from an area in which the ignition coil is placed to an area in which the ignition plug is placed, in which the passage portion is arranged on the upper face side of the engine cover.

### Effects of the Invention

The portable work machine according to the present invention has a routing structure for the high voltage cord improved by providing the upper face side of the engine case that houses an engine in its internal space with a passage portion for housing and guiding the high voltage cord on a route from an area in which the ignition coil is placed to an area in which the ignition plug is placed. This improved routing structure increases durability and ease of assembly and maintenance of the high voltage cord with respect to the engine case, and eliminates the possibility that the high voltage cord might come into contact with the metal parts of the engine, thus improving durability of the high voltage cord to curb a decrease in the secondary voltage for ignition.

### BRIEF DESCRIPTION OF THE DRAWINGS

FIG. 1 is a left side view of the portable work machine according to the present invention with a left side cover removed therefrom.

FIG. 2 is an exploded perspective view of the portable work machine with both the left side cover and an operation handle on the upper face of an engine case removed therefrom.

FIG. 3 is a plan view of the portable work machine with the operation handle on the upper face of the engine case removed therefrom.

FIG. 4 is a right side view of the portable work machine from which with a muffler cover on the right side of the engine case removed therefrom.

### MODE FOR CARRYING OUT THE INVENTION

Hereinafter, an embodiment of the present invention will be described with reference to the attached drawings.

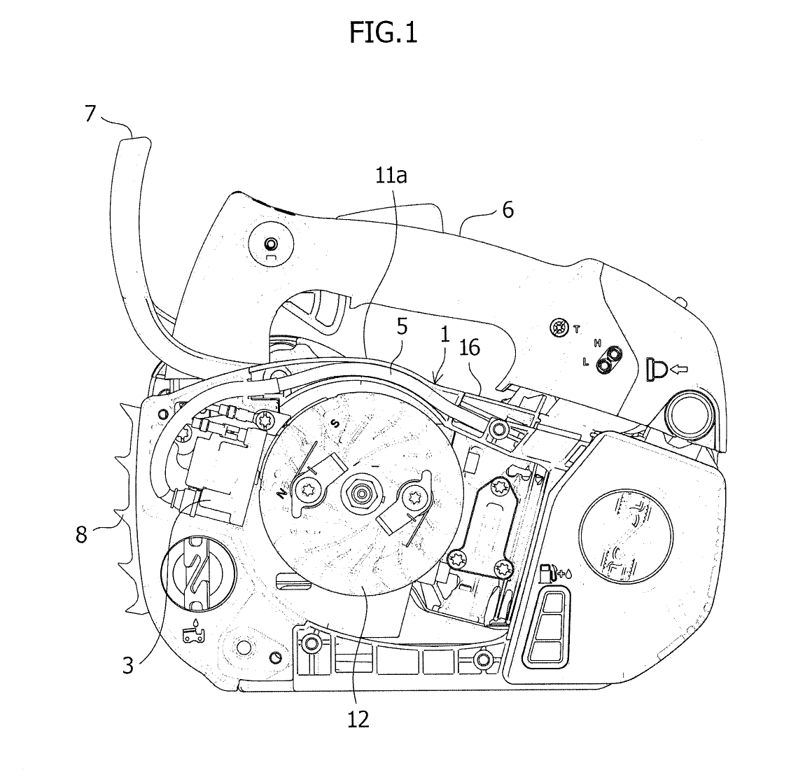

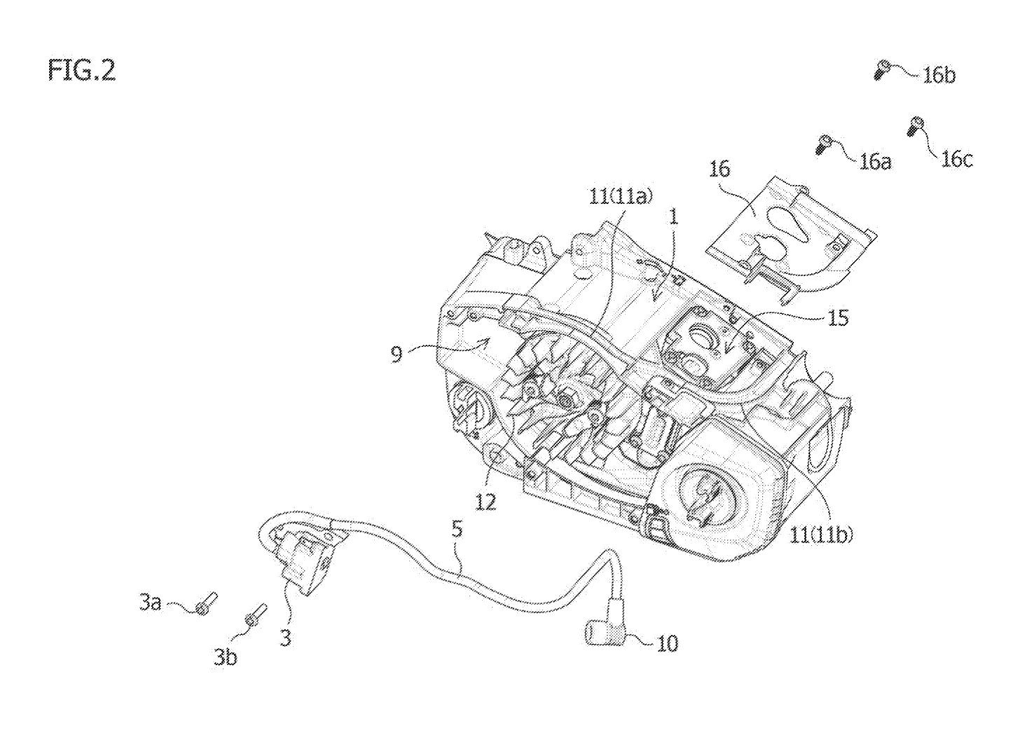

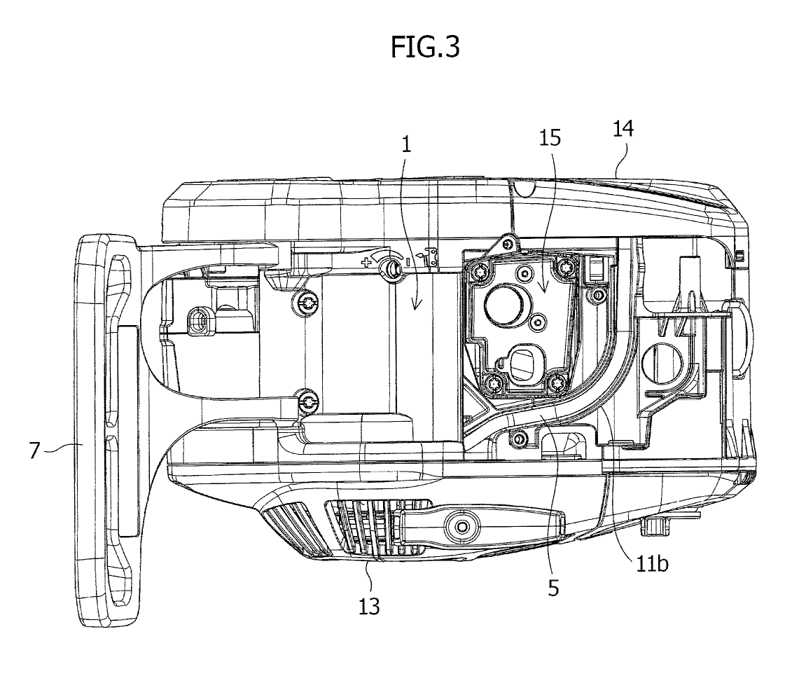

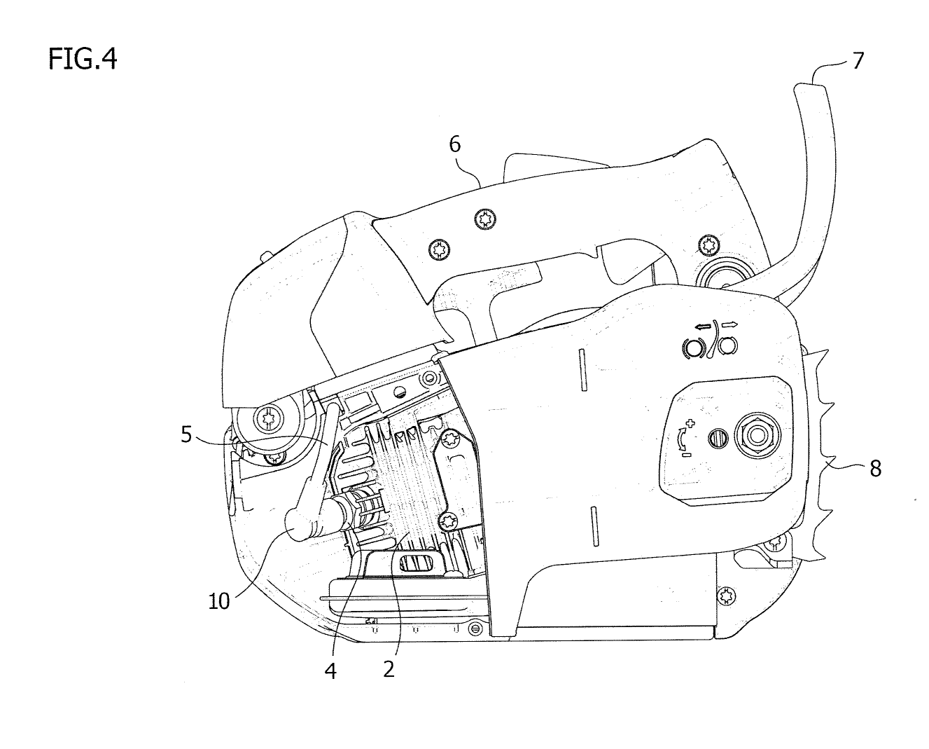

FIG. 1 is a left side view of a portable work machine according to the present invention with a left side cover removed therefrom. FIG. 2 is an exploded perspective view of the portable work machine with both the left side cover and the operation handle on the upper face of an engine case removed therefrom. FIG. 3 is a plan view of the portable work machine with the operation handle on the upper face of the engine case removed therefrom. FIG. 4 is a right side view of the portable work machine with a muffler cover on the right side of the engine case removed therefrom.

The present invention is to be applied to a portable work machine, such as a chainsaw, a brush cutter or an air blower, which is powered by an engine. FIGS. 1 to 4 show an example in which the present invention is applied to a chainsaw. The chainsaw, as a portable work machine, is powered by an engine to cut wood or the like with a guide bar and a saw chain attached thereto as work parts. In the chainsaw, the engine 2 (see FIG. 4) is placed in the internal space of the engine case 1 (see FIG. 2), and the ignition coil 3 (see FIG. 1) for igniting the engine is disposed utilizing the engine case 1. Moreover, the chainsaw includes the high voltage cord 5 (see FIGS. 1 and 2) routed from an area in which the ignition coil 3 is placed to an area in which an ignition plug 4 (see FIG. 4) of the engine 2 is placed.

The working parts for cutting wood or the like include the guide bar that has an elongate plate shape and is coupled at the vicinity of a rotary drive part powered by the engine 2, and the saw chain wound around the periphery of the guide bar to run thereon. These working parts, the guide bar and the saw chain, are not shown in FIGS. 1 to 4.

In FIG. 1, reference numeral 6 denotes an operation handle placed on the upper face of the engine case 1, reference numeral 7 denotes a front hand guard for braking and stopping the cutting operation at the time of an emergency, and reference numeral 8 denotes spikes that engage with the object being cut such as wood or the like and prevent the chainsaw from being displaced with respect to the object during the cutting operation. The operation handle 6 is sometimes called a top handle, and the chainsaw provided with such top handle is called a top handle chainsaw or a top handle saw.

The engine case 1 shown in FIG. 2 has an approximately C shape when viewed from a side, and the engine 2 is positioned horizontally in an internal space between the upper and lower plate portions of the C shape, as shown in FIG. 4. The ignition coil 3 is provided in a mounting recess 9 (see FIG. 2) formed on the left side of the engine case 1 and at the front end of the upper plate portion, and fixed in the mounting recess 9 with screws 3a and 3b, as shown in FIG. 1. The ignition plug 4 is provided on the top of the cylinder part of the engine 2 (see FIG. 4) which is horizontally positioned in an innermost area of the internal space of the C-shaped engine case 1. In other words, the ignition coil 3 is located at a first side end (front end) on one side (left side) of the engine case 1 while the ignition plug 4 is located at a second side end (rear end), which is located opposite to the first side end where the ignition coil is located, on the other side (right side) of the engine case 1.

As shown in FIGS. 1 to 4, the high voltage cord 5 is routed to connect the ignition coil 3 to the ignition plug 4. The high voltage cord 5 supplies the ignition plug 4 with a high voltage (secondary voltage for ignition) generated by the ignition coil 3. Note that, in FIG. 2, reference numeral 10 denotes a plug cap that is put on the head of the ignition plug 4 when connecting it to the high voltage cord 5.

Here, in the present invention, a passage portion 11 for housing and guiding the high voltage cord 5 on the route from the area in which the ignition coil 3 is placed to the area in which the ignition plug 4 is placed is arranged on the upper face side of the engine case 1, as shown in FIG. 2. The passage portion 11 houses the high voltage cord 5 to guide it from the ignition coil 3 to the ignition plug 4. The passage portion 11 includes a first passage portion 11a located right above a cooling fan 12, and a second passage portion 11b traversing a rear portion of the upper face of the engine case 1 shown in FIG. 2.

The passage portion 11 (11a and 11b) is placed to be routed in continuous curves from the area in which the ignition coil 3 is placed to the area in which the ignition plug 4 is placed. In addition, the passage portion 11 (11a and 11b) is formed to have a groove shape with a U-shaped cross section so as to house the high voltage cord 5. Specifically, in FIG. 2, the first passage portion 11a is formed on the left side of the engine case 1 and is curved in a gentle circular arc (see FIG. 1) along the outer periphery, above the cooling fan 12, of the engine case 1. Meanwhile, the second passage portion 11b is formed on the upper side of the engine case 1 and is curved in an approximately quarter-circular arc (see FIG. 3) that circumvents an area through which portions, connecting the intake flange part of the cylinder to the carburetor cabin, of an intake pipe and the like pass. These first and second passage portions 11a and 11b are connected together at mutually adjacent ends to be routed in continuous curves. Note that a single continuous curved member may be formed in place of the first and second passage portions 11a and 11b.

In this way, the first and second passage portions 11a and 11b are connected together to form a single continuous curved member as the passage portion 11 (11a and 11b), and this passage portion 11 (11a and 11b) is provided on the upper side of the engine case 1 on the route from the area in which the ignition coil 3 is placed to the area in which the ignition plug 4 is placed. In addition, the high voltage cord 5 is housed in the U-shaped cross-section groove of the passage portion 11 (11a and 11b). As a result, substantially the entire length of the high voltage cord 5 is housed and guided in this dedicated passage, which facilitates assembly and maintenance of the machine. In addition, housing the high voltage cord 5 in the passage portion 11 eliminates the possibility that the high voltage cord 5 might come into contact with metal parts which are heated to a high temperature while the engine 2 is running, thus improving durability of the high voltage cord 5 and curbing a decrease in the secondary voltage for ignition.

As shown in FIG. 3, a side cover 13 is detachably attached to the engine case 1 so as to cover an area (the front half of the left side of the engine case 1) in which the ignition coil 3 is placed. A muffler cover 14 is detachably attached to the engine case 1 so as to cover an area (the rear half of the right side of the engine case 1) in which the ignition plug 4 is placed. In addition, a piping hole 15 that has an approximately rectangular shape is formed in an area through which a portion, connecting the intake flange part of the cylinder to the carburetor cabin, of an air-fuel mixture passage passes. The second passage portion 11b is placed in the vicinity of the piping hole 15.

The second passage portion 11b works as a reinforcing member for reinforcing a part of the periphery of the piping hole 15 formed in the area through which the air-fuel mixture passage to the engine 2 passes. To the approximately rectangular piping hole 15, a lid member 16 is detachably attached by screwing with screws 16a, 16b and 16c, as shown in FIG. 2. Attaching the lid member 16 onto the approximately rectangular piping hole 15 formed in the upper face of the engine case 1, in addition to providing the second passage portion 11b (reinforcing member) having the U-shaped cross-section groove shape to the upper face, increases the strength and stiffness of the upper face of the engine case 1.

Next, how to use the portable work machine configured as above will be described. In assembling the portable work machine, the ignition coil 3 (with the high voltage cord 5 connected thereto) is first mounted, with the screws 3a and 3b, in the mounting recess 9 formed at the front end on the left side the engine case 1 with none of the side cover 13, the muffler cover 14 (FIG. 3) and the operation handle 6 (see FIG. 1) attached thereto, as shown in FIG. 2. Then, the free end of the high voltage cord 5 is inserted from an insertion end of the first passage portion 11a so that the high voltage cord 5 can be pushed into the first passage portion 11a. As a result, the high voltage cord 5 is guided to follow the U-shaped cross-section groove of the first passage portion 11a and then to enter the second passage portion 11b, as shown in FIG. 1. Thereafter, the high voltage cord 5 is guided to follow the U-shaped cross-section groove of the second passage portion 11b. When the high voltage cord 5 reaches the right side of the engine case 1 to come closer to the ignition plug 4 of the engine 2 as shown in FIG. 4, the free end of the high voltage cord 5 comes out from the engine case 1. After that, the free end of the high voltage cord 5 is connected to the plug cap 10, and the plug cap 10 is then put on the head of the ignition plug 4. In this way, the high voltage cord 5 is routed to connect the ignition coil 3 to the ignition plug 4.

Thereafter, the side cover 13 is attached to the left side of the engine case 1 as shown in FIG. 1, and the muffler cover 14 is attached to the right side of the engine case 1 shown in FIG. 4. Then, the lid member 16 is attached onto the piping hole 15 formed in the upper face of the engine case 1, and the operation handle 6 is mounted on this upper face as shown in FIG. 3. In this way, the portable work machine is assembled.

When the portable work machine is used as a chainsaw, the guide bar and the saw chain, being the work parts, are additionally attached to the front side of the engine case 1 after attaching the side cover 13 (see FIG. 3) and the muffler cover 14 (see FIG. 3) to the engine case 1 in the condition shown in FIG. 1. The portable work machine assembled as above is powered by the engine 2 to cut wood or the like with the operation handle 6 grasped by a hand.

To repair or replace the high voltage cord 5 for maintenance, the muffler cover 14 is detached from the right side of the engine case 1 as shown in FIG. 4, and the plug cap 10 is removed from the ignition plug 4 and then from the end of the high voltage cord 5. Thereafter, the side cover 13 is detached from the left side of the engine case 1 as shown FIG. 1, and the high voltage cord 5 is pulled back by grasping the base end thereof. Thereby, the high voltage cord 5 is pulled back along the route of the passage portion 11 as guided by the U-shaped cross-section groove of the first and second passage portions 11a and 11b, and eventually pulled out to the outside. Then, the high voltage cord 5 is repaired or replaced after the ignition coil 3 is removed therefrom.

After finishing the maintenance of the high voltage cord 5, the portable work machine can be reassembled after routing the high voltage cord 5 in the reverse procedure to the above, that is, by inserting the high voltage cord 5 through the second passage portion 11b and the first passage portion 11a in this order. Thus, it is basically only necessary to detach or attach the side cover 13 from/to the left side of the engine case 1 and the muffler cover 14 from/to the right side of the engine case 1 before or after the maintenance works. Therefore, assembly and maintenance works for the high voltage cord 5 with respect to the engine case 1 can be performed more easily. In addition, housing the high voltage cord 5 in the passage portion 11 eliminates the possibility that the high voltage cord 5 might come into contact with the metal parts of the engine 2, thus improving durability of the high voltage cord 5 to curb a decrease in the secondary voltage for ignition. Moreover, the strength and stiffness of the upper wall of the engine case 1 can be improved by causing the passage portion (the second passage portion 11b) to work as the reinforcing member for reinforcing the part of the periphery of the piping hole 15 formed in the area through which the air-fuel mixture passage to the engine 2 passes.

### REFERENCE SYMBOL LIST

1 Engine case
2 Engine
3 Ignition coil
4 Ignition plug
5 High voltage cord
6 Operation handle
11a First passage portion
11b Second passage portion
12 Cooling fan
13 Side cover
14 Muffler cover
15 Piping hole
16 Lid member

1. A portable work machine including an engine placed in an internal space of an engine case, an ignition plug of the engine, and an ignition coil for igniting the engine which is connected to the ignition plug by means of a high voltage cord, the portable work machine comprising a passage portion for housing and guiding the high voltage cord on a route from an area in which the ignition coil is placed to an area in which the ignition plug is placed,
wherein the passage portion is arranged on an upper face side of the engine case.

2. The portable work machine according to claim 1, wherein the passage portion is configured to work as a reinforcing member for reinforcing a part of a periphery of a piping hole formed in an area through which an air-fuel mixture passage to the engine passes.

3. The portable work machine according to claim 1, wherein the passage portion is arranged to have a continuous curve portion on the route from the area in which the ignition coil is placed to the area in which the ignition plug is placed.

4. The portable work machine according to claim 1, wherein the passage portion is formed to have a groove shape with a U-shaped cross section so as to house the high voltage cord.

5. The portable work machine according to claim 1, wherein the ignition coil is placed at a first side end on one side of the engine case while the ignition plug is placed at a second side end, which is located opposite to the first side end, on the other side of the engine case.

6. The portable work machine according to claim 1, wherein the portable work machine includes a side cover which is configured to be detachably attached to the engine case to cover an area in which the ignition coil is placed, and a muffler cover which is configured to be detachably attached to the engine case to cover an area in which the ignition plug is placed.

7. The portable work machine according to claim 1, wherein the ignition coil is configured to be detachably attached to the engine case.

8. The portable work machine according to claim 7, wherein the engine case has a mounting recess to which the ignition coil is attached,
wherein the passage portion is formed to have a groove shape with a U-shaped cross section, and
wherein an opening of the mounting recess and an opening of the passage portion face in same direction.
